(19) United States
(12) Patent Application Publication
(10) Pub. No.: US 2005/0077742 A1
(43) Pub. Date: Apr. 14, 2005

(54) Gripping apparatus and method for hand-held objects

(76) Inventor: Sherman Evan Wilson, Apopka, FL (US)

Correspondence Address: BAKER & HOSTETLER LLP;Washington Square, Suite 1100, 1050 Connecticut Avenue, N.W., Washington, DC, 20036, US

(21) Appl. No.: 10/680,176

(22) Filed: Oct. 8, 2003

(51) Int. Cl. B65G 7/12

(52) U.S. Cl. 294/25

(57) ABSTRACT

A method and apparatus that includes an arm wrap includes an exterior surface and an interior surface, a fastener attached to an edge of the arm wrap, the fastener is configured to fasten the arm wrap into an enclosed position and a holder attached to the arm wrap, the holder is configured to secure the object.

### FIELD OF THE INVENTION

The present invention relates generally to devices which facilitate the gripping of hand-held objects. More particularly, the present invention relates to an apparatus which allows a person with limited use of his or her hand or wrist to securely grip various hand-held objects, such as writing instruments and eating utensils.

### BACKGROUND OF THE INVENTION

A growing number of people have limited use of their hands and wrists due to a variety of causes, ranging from diseases such as arthritis to the loss of strength as a result of old age. Whatever the cause, any material limitation on the use of one's hands or wrists can severely affect such person's ability to perform simple tasks such as writing (via the use of a pen, pencil or other writing instrument), preparing and eating (via the use of kitchen utensils), and other tasks that involve the gripping of hand-held objects.

Several types of existing devices have been created that are ostensibly designed to aid persons with limited use of their hands or wrists in gripping certain hand-held objects. A majority of these devices were designed to allow persons to grip or hold only particular hand-held objects. For example, U.S. Pat. No. 5,557,805 to Emerson discloses a device which enables a person with limited or no use of a hand to hold a golf club. U.S. Pat. No. 5,383,737 to Urion discloses a device, which enables a person with limited use of a hand to hold and use a pen or pencil. The foregoing devices are limited in their application to only a few specified tasks. Other devices were designed to allow persons to grip a variety of hand-held objects but only in a fixed position, thus limiting their application.

Other devices allow persons to grip a variety of hand-held objects in a variety of positions, however, additional components are required to be attached. For example, U.S. Pat. No. 5,853,210 to Robinson discloses a device that involves the insertion of various accommodating devices to grip various hand-held objects. Persons, who already have limited use of their hands, are required to detach one device and attach another in order to grip differing items.

Accordingly, it is desirable to provide a method and apparatus that allows a person with limited use of their hands or wrist to grip a variety of hand-held objects in a variety of positions without the insertion of accommodating devices.

### SUMMARY OF THE INVENTION

The foregoing needs are met, to a great extent, by the present invention, wherein in one embodiment an apparatus permits one with limited use of their hands or wrists to grip a variety of hand-held objects in a variety of positions without the insertion of accommodating devices.

In accordance with one embodiment of the present invention, the apparatus includes an arm wrap which includes an exterior surface and an interior surface. The apparatus also includes a fastener attached to an edge of the arm wrap. The fastener is configured to fasten the arm wrap into an enclosed position, A holder is further included and attached to the arm wrap. The holder is configured to secure the object.

In accordance with another embodiment of the present invention, a method of gripping an object is provided which includes positioning an arm wrap around an arm. The method also includes securing the arm wrap around the arm and placing the object in a band that is attached to the arm wrap.

In accordance with yet another embodiment of the present invention, a system for gripping an object is provided which includes means for encasing an arm. The system also includes means for securing the means for encasing the arm, and means for holding the object attached to the means for encasing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an apparatus for gripping hand-held objects in use according to a preferred embodiment of the invention.

FIG. 2 is a top view of the holding apparatus.

FIG. 3 is a bottom view of the holding apparatus.

FIG. 4 is an internal view of the holding apparatus.

FIG. 5 is a bottom view of the pad.

FIG. 6 is a cross-sectional view taken along the line 5-5 in FIG. 2.

### DETAILED DESCRIPTION

The invention will now be described with reference to the drawing figures, in which like reference numerals refer to like parts throughout. An embodiment in accordance with the present invention allows an individual with limited use of their hands or wrist to grip a variety of hand-held objects in a variety of positions without the insertion of accommodating devices. The apparatus includes an arm wrap, fasteners for securing the arm wrap about the arm, a holder securing certain hand-held objects to arm wrap, and a removable pad.

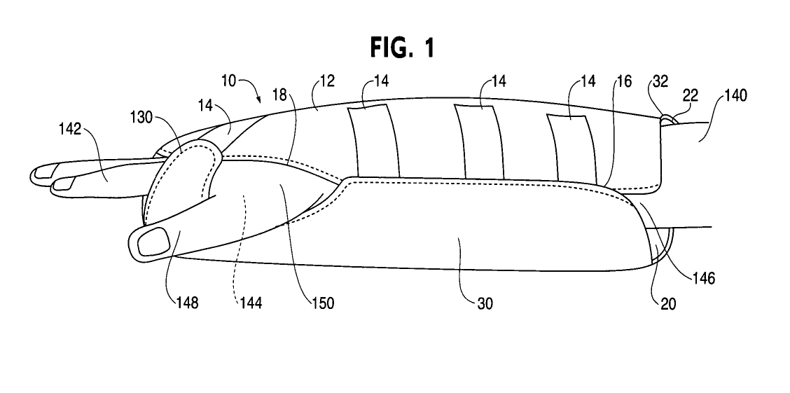

An embodiment of the present inventive apparatus and method is illustrated in FIG. 1. FIG. 1 shows a gripping apparatus 10 in use. An arm wrap 12 is enclosed around a portion of the arm 140 which includes some portion of the fingers 142, the palm 144 and the forearm 146, with the attaching edge 16 of the arm wrap meeting the receiving edge 18 of the arm wrap 12, leaving an opening 150 for the thumb 148. The apparatus 10 is secured on such portion of the arm by fasteners 14, which in this embodiment are loop and hook systems, which is known as VELCRO™.

The arm wrap 12 includes the outer or exterior wrap portion 30, which is attached to an inner or interior wrap portion 20 by attaching all edges of the outer wrap portion 30, other than the bottom edge 32, to all edges of the inner wrap portion 20 other than the bottom edge 22 with stitches 130. Both the inner wrap portion 20 and the outer wrap portion 30 of the arm wrap 12 consist of a fabric material. In the preferred embodiment, the fabric material is a durable fabric to ensure the longevity of the arm wrap 12. For example, the embodiment described herein includes a felt fabric.

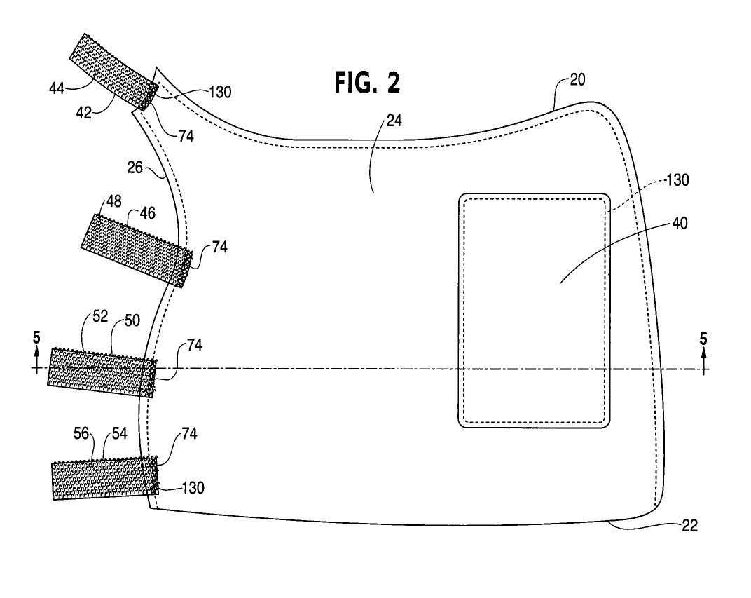

Referring to FIG. 2, apparatus 10 is seen in an open, unwrapped position, showing the interior surface 24 of the arm wrap 12. A non-abrasive portion 40 includes a rectangular shaped piece of fabric material, which is attached with stitches 130, to that portion of the interior surface 24 that engages the top of the arm 140 when the apparatus 10 is in an enclosed position as shown in FIG. 1. The fabric material, in the preferred embodiment, of the non-abrasive portion 40 is a higher-quality fabric than the fabric material of the arm wrap 12 due to its direct contact with the top of the arm 140. For example, the preferred embodiment includes a rectangular-shaped piece of spandex fabric. The higher quality fabric provides comfort to the user and reduces the likelihood of the fabric snagging onto a watch or other jewelry worn on the arm 140.

Strip 42 is attached on the attaching edge 26 of the interior surface 24 near the top edge 28 of the inner wrap portion 20 and above the opening 150 formed when the apparatus 10 is in an enclosed position as shown in FIG. 1. Three other strips 46, 50, 54 are located at even intervals along the attaching edge 26 of the interior surface 24 beginning at the bottom edge 22 of the inner wrap portion 20 and ending below the opening 150 formed when the apparatus 10 is in an enclosed position as shown in FIG. 1. Strip 42 includes one or more hooks on the upper surface 44 of strip 42; strip 46 includes one or more hooks on the upper surface 48 of strip 46; strip 50 includes one or more hooks on the upper surface 52 of strip 50; and strip 54 includes one or more hooks on the upper surface 56 of strip 54. Strips 42, 46, 50 and 54 are attached to the interior surface 24 at the connecting edge 74 of such strips by stitches 130.

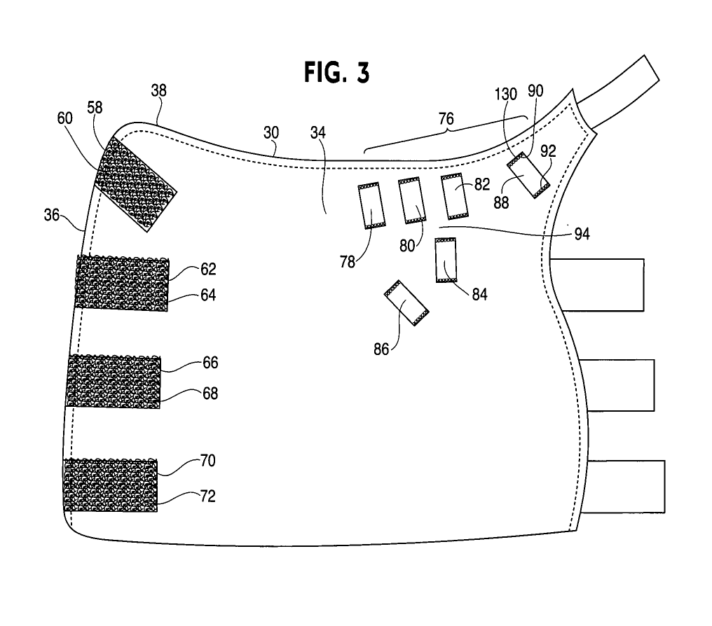

Referring now to FIG. 3, apparatus 10 is seen in an open, unwrapped position, showing the exterior surface 34 of the arm wrap 12. The holder 76 for securing certain hand-held objects includes one or more bands 78. In the preferred embodiment, there are six bands, bands 78, 80, 82, 84, 86 and 88, and the bands are rectangular-shaped, which aids in securing an object. Other embodiments can include any number of bans and a vast number of differing sizes or shapes.

The bands 78, 80, 82, 84, 86 and 88 are attached by stitches 130 along the first end 90 and second end 92 of each band, to the palm portion 94 of the exterior surface 34 that is exposed under the palm 144 and thumb 148 of the arm 140 when the apparatus 10 is in an enclosed position as shown in FIG. 1, located at various points on the palm portion 94. In the preferred embodiment, the bands 78, 80, 82, 84, 86 and 88 are positioned in such a manner to hold various hand-held objects in a variety of positions. Various hand-held objects, such as a writing instrument or eating utensil, may be inserted through one or more of the bands. A hand-held object is secured to the palm 144 through the air of the holder 76.

By using the holder 76, the intensity of the grip of the person needed to hold an object is reduced. Although the bands 78, 80, 82, 84, 86 and 88 can be made of any fabric material, the bands are made of elastic in the preferred embodiment. Elastic material provides for easier insertion of hand-held objects and holds the objects in place more securely.

Strip 58 is attached on the receiving edge 36 on the exterior surface 34 located near the top edge 38 of the outer wrap portion 30 such that it meets and overlaps strip 42 when the apparatus 10 is in an enclosed position as shown in FIG. 1. Three strips 62, 66 and 70 are located at even intervals along the receiving edge 36 on the exterior surface 34 such that they meet and overlap strips 46, 50 and 54 when the apparatus 10 is in an enclosed position as shown in FIG. 1. Strip 58 includes one or more loops on the upper surface 60 of strip 58, strip 62 includes one or more loops on the upper surface 64 of strip 62, strip 66 includes one or more loops on the upper surface 68 of strip 66, and strip 70 includes one or more loops on the upper surface 72 of strip 70. Strips 58, 62, 66 and 70 are fastened to the exterior surface 34. The preferred embodiment uses a glue to fasten the strips. Other embodiments can use stitching, self-adhesive strips or other methods. Together, strips 42, 46, 50 and 54 and strips 58, 62, 66 and 70, respectively, form hook and loop closures. These types of fasteners are useful due to their adjustable nature. Although an example of the apparatus is shown using four hook and loop-type fasteners, it will be appreciated that such fasteners could number as few as two (one on either side of opening 150) and as many as will fit on the arm wrap. Also, it is anticipated that other fasteners could be used in lieu of the hook and loop system.

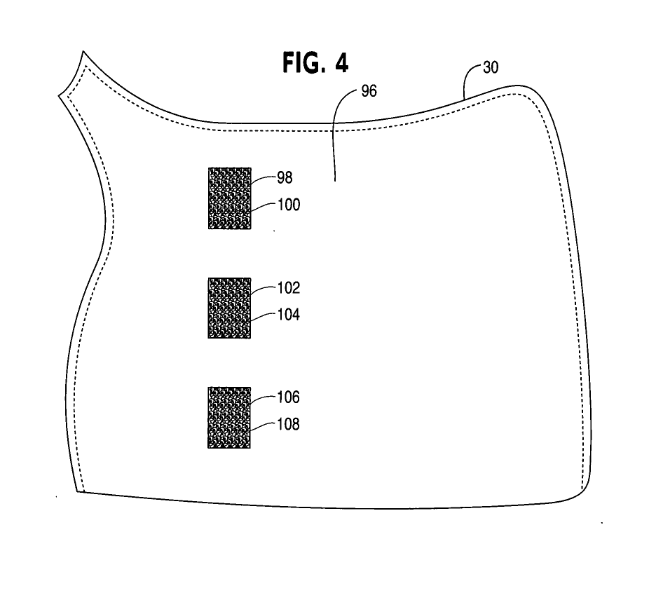

Referring now to FIG. 4, the unexposed surface 96 of the outer wrap portion 30 of the apparatus 10. Three strips 98, 102 and 106 are located at even intervals along that portion of the unexposed surface 96 of the outer wrap portion 30 that engages the palm 144 and the arm 140 when the apparatus 10 is in an enclosed position as shown in FIG. 1. Strips 98, 102 and 106 each include one or more loops on their respective upper surfaces 100, 104 and 108. Strips 98, 102 and 106 are attached to the unexposed surface 96 of the outer wrap portion 30 with a fastening method such as a glue. Other embodiments can use stitching, self-adhesive strips or other methods.

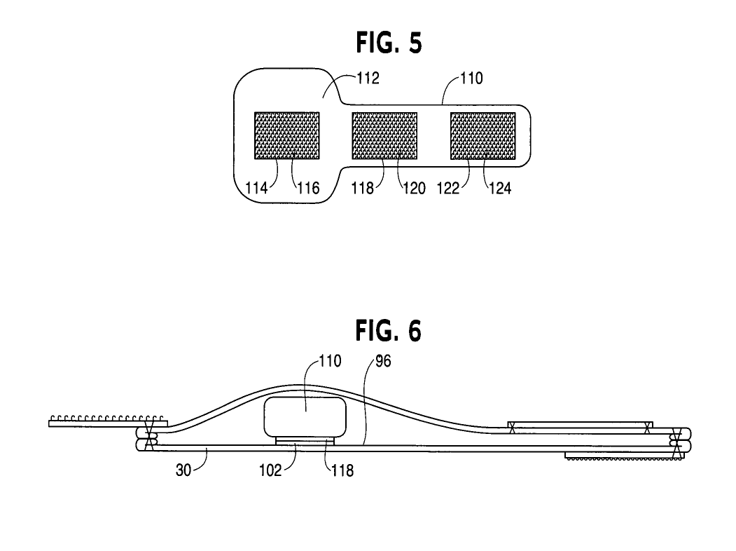

Referring now to FIG. 5, a pad 110 consists of a “T”-shaped foam cushion 112 with three strips 114, 118 and 122. Strips 114, 118 and 122 are located along the center of the cushion 112 at the same intervals of strips 98, 102 and 106 located on the unexposed surface 96 of the outer wrap portion 30. Strips 114, 118 and 122 each include one or more hooks on their respective upper surfaces 116, 120 and 124. Strips 114, 118 and 122 are attached to the cushion 112 with a fastening method such as a glue. Other embodiments can use stitching, self-adhesive strips or other methods.

Referring now to FIG. 6, a cross section of apparatus 10 is shown which demonstrates how the pad 110 is removably attached to the outer wrap portion 30 by attaching the strips 98, 102 and 106 on the unexposed surface 96 of the outer wrap portion 30 to the strips 114, 118 and 122 on the pad 110. Together, strips 98, 102 and 106 and strips 114, 118 and 122, respectively, form a hook and loop type closure. Although an example of the apparatus 10 is shown using three sets hook and loop-type connecting strips, it will be appreciated that such sets could number as few as two and as many as will fit on the pad 110.

The pad 110 serves two functions. First, the pad 110 reduces the space between the hand-held objects and the fingers and thus reduces the strength needed to grip the hand-held objects that are placed in the holder 76. Also, the pad 110 provides the user comfort when in use.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for aiding in the gripping of an object comprising:
an arm wrap comprising an exterior surface and an interior surface;
a fastener attached to an edge of the arm wrap, the fastener is configured to fasten the arm wrap into an enclosed position; and
a holder attached to the arm wrap, the holder is configured to secure the object.

2. The apparatus as in claim 1, wherein the holder is attached to the exterior surface.

3. The apparatus as in claim 2, wherein the holder is located on a palm region of the exterior surface.

4. The apparatus as in claim 1, wherein the holder is a band secured on the arm wrap at each end.

5. The apparatus as in claim 4, wherein the band is elastic.

6. The apparatus as in claim 1, wherein the arm wrap is configured to fit around a hand.

7. The apparatus as in claim 1, further comprising a pad positioned on the arm wrap.

8. The apparatus as in claim 7, wherein the pad is positioned around a palm region of a hand.

9. The apparatus as in claim 1, wherein the fastener is attached to an edge of the exterior surface.

10. The apparatus as in claim 1, wherein the fastener is attached to an edge of the interior surface.

11. The apparatus as in claim 1, wherein the fastener is a hook and loop system.

12. The apparatus as in claim 9, further comprising a second fastener attached to an edge of the interior surface.

13. The apparatus as in claim 10, wherein the fastener is a hook.

14. The apparatus as in claim 12, wherein the second fastener is a loop.

15. The apparatus as in claim 1, wherein the arm wrap is adjustable.

16. A method of gripping an object comprising:
positioning an arm wrap around an arm;
securing the arm wrap around the arm; and
placing the object in a band that is attached to the arm wrap.

17. The method as in claim 16, wherein the arm wrap is comprised of an exterior surface and an interior surface.

18. The method as in claim 17, wherein the arm wrap is further comprised of a fastener that is attached to an edge of the exterior surface.

19. The method as in claim 17, wherein the arm wrap is further comprised of a fastener that is attached to an edge of the interior surface.

20. The method as in claim 18, wherein the fastener is a hook and loop system.

21. The method as in claim 17, wherein the interior surface is wrapped around the arm.

22. The method as in claim 21, wherein the fastener is attached to an opposing edge of the exterior surface to secure the arm wrap around the arm.

23. A system for gripping an object comprising:
means for encasing an arm;
means for securing the means for encasing around the arm; and
means for holding the object attached to the means for encasing.

24. The system as in claim 23, wherein the means for encasing the arm is an arm wrap.

25. The system as in claim 24, wherein the arm wrap is comprised of an exterior surface and an interior surface.

26. The system as in claim 25, wherein the arm wrap is further comprised of a fastener that is attached to an edge of the exterior surface.

27. The system as in claim 24, wherein the arm wrap is further comprised of a fastener that is attached to an edge of the interior surface.

28. The system as in claim 27, wherein the fastener is a hook and loop system.

29. The system as in claim 25, wherein the interior surface is wrapped around the arm.

30. The system as in claim 27, wherein the fastener is attached to an opposing edge of the exterior surface to secure the arm wrap around the arm.
